(19) United States
(12) Patent Application Publication
(10) Pub. No.: US 2009/0308953 A1
(43) Pub. Date: Dec. 17, 2009

(54) ATOMIZING NOZZLE

(75) Inventors: Laurence Palestrant, Scottsdale, AZ (US); Herb L. Andrews, Phoenix, AZ (US)

Correspondence Address: MESCHKOW & GRESHAM, P.L.C., 5727 NORTH SEVENTH STREET, SUITE 409, PHOENIX, AZ, 85014, US

(73) Assignee: AMFOG NOZZLE TECHNOLOGY, INC., Tempe, AZ (US)

(21) Appl. No.: 12/140,138

(22) Filed: Jun. 16, 2008

(51) Int. Cl. B05B 1/34

(52) U.S. Cl. 239/461; 239/589; 239/380; 239/569

(57) ABSTRACT

An atomizing nozzle (20) configured to convert a fluid (88) into a mist (92) for use in a misting system is provided. The atomizing nozzle (20) has a nozzle body (22) encompassing a cylindrical occluder chamber (50), a substantially spherical occluder (26) residing within the occluder chamber (50), and an orifice insert (24) affixed to an outlet end (44) of the atomizing nozzle (20). The orifice insert (24) encompasses an insert chamber (74) contiguous with the occluder chamber (50) and having a conical chamber bevel (76) proximate an outlet end (78) of the insert chamber (74), and has a mating surface (82) configured to mate with the occluder (26). The mating surface (82) has at least one flow-control groove (86) configured to control the flow of the fluid (88) through the atomizing nozzle (20).

### TECHNICAL FIELD OF THE INVENTION

The present invention relates generally to fluid atomizing nozzles. Specifically, the present invention relates to atomizing nozzles that are configured to consistently produce a uniform fine mist.

### BACKGROUND OF THE INVENTION

Atomizing nozzles, also called mist heads, are used in connection with misting systems to produce a fog or fine mist. A fluid, typically water, is forced under pressure through the atomizing nozzles to produce the mist. Desirably, the mist is sufficiently fine so that it rapidly evaporates. As the mist evaporates, the general area around the atomizing nozzles becomes cooler. Rapid evaporation enhances the cooling effect while preventing people and property located in the mist from becoming overly wet. Accordingly, misting systems are often used for cooling and for increasing humidity.

In order to produce a fog or fine mist that quickly evaporates, atomizing nozzles conventionally incorporate a small outlet orifice through which the fluid passes under pressure to produce the desired fog or mist. In addition, a cylindrical or conical impeller, also called a plunger or poppet, is positioned within a fluid chamber from which the orifice provides fluid egress. The action of the impeller within the passage serves to fracture the fluid, resulting in a finer fog or mist.

One of the disadvantages of a cylindrical impeller is that, if the impeller is not perfectly aligned in the chamber, an inconsistent spray pattern and flow rate may result. This problem increases over time as deposits build on the impeller. These deposits create an uneven distribution of weight, resulting in more frequent improper orientations of the impeller within the fluid chamber.

Cylindrical impellers typically have one or more grooves that cause the impeller to vibrate and spin during operation. With the buildup of calcium and other deposits upon internal parts of the nozzle, the grooves on the impeller may catch and hang up on these deposits, stopping the movement of the impeller and interfering with proper nozzle operation.

Another disadvantage of current nozzle designs is that only a single variable, the size of the nozzle orifice, may be used to effect changes to the spray pattern and/or flow rate of the nozzle under a consistent pressure and with a given nozzle body. Changes in the nozzle body itself are often required to effect changes in flow rate. Since, in most circumstances, the nozzle body is the most expensive component of the nozzle to produce, the production of a plurality of different nozzle bodies is simply not cost effective.

What is desirable, therefore, would be an atomizing nozzle configured to eliminate the problems of impeller misalignment, and to allow increased control over the spray pattern and flow rate of a plurality of different nozzle utilizing a common nozzle body.

### SUMMARY OF THE INVENTION

Accordingly, it is an advantage of one embodiment of the present invention that an atomizing nozzle with a spherical occluder is provided.

It is another advantage of one embodiment of the present invention that an atomizing nozzle is provided that uses a spherical occluder in lieu of a cylindrical impeller to reduce significantly the possibility of impeller misalignment.

It is another advantage of one embodiment of the present invention that an atomizing nozzle is provided that incorporates the use of fixed grooves to control the flow of fluid through the nozzle.

It is another advantage of one embodiment of the present invention that an atomizing nozzle is provided that incorporates an orifice bevel to control a mist spray pattern.

The above and other advantages of the present invention are carried out in one form by an atomizing nozzle for use in a misting system, where the atomizing nozzle includes a nozzle body having an inlet end, having an outlet end, and comprising an occluder chamber, an orifice insert configured to be affixed to the nozzle body proximate the outlet end and comprising a substantially cylindrical insert chamber configured to be contiguous with the occluder chamber, and a substantially spherical occluder configured to reside within the occluder chamber.

The above and other advantages of the present invention are carried out in another form by an atomizing nozzle for use in a misting system, where the atomizing nozzle includes a nozzle body incorporating an occluder chamber formed therein and substantially coaxial with a nozzle axis, an orifice insert made up of a substantially cylindrical insert chamber configured to be substantially coaxial with the nozzle axis, a mating surface formed at a chamber end of the orifice insert, and a flow-control groove formed into the mating surface of the orifice insert and configured to extend from the occluder chamber to the insert chamber, and an occluder configured to reside within the occluder chamber and mate with the mating surface.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a front view of an atomizing nozzle in accordance with a preferred embodiment of the present invention;

FIG. 2 shows a top view of the atomizing nozzle of FIG. 1 in accordance with a preferred embodiment of the present invention;

FIG. 3 shows an exploded front view of the atomizing nozzle of FIGS. 1 and 2 demonstrating components thereof in accordance with a preferred embodiment of the present invention;

FIG. 4 shows an exploded cross-sectional front view of the atomizing nozzle of FIGS. 1 and 2 taken at line 4-4 of FIG. 2 and demonstrating the internal structure thereof in accordance with a preferred embodiment of the present invention;

FIG. 5 shows an exploded cross-sectional front view of the atomizing nozzle of FIGS. 1 and 2 taken at line 4-4 of FIG. 2 and demonstrating dimensional properties of the internal structure thereof in accordance with a preferred embodiment of the present invention;

FIG. 6 shows a bottom view of an orifice insert for the atomizing nozzle of FIGS. 1 and 2 demonstrating flow-control grooves in accordance with a preferred embodiment of the present invention;

FIG. 7 shows a cross-sectional front view of the atomizing nozzle of FIGS. 1 and 2 taken at line 4-4 of FIG. 2 and demonstrating the operation thereof in accordance with a preferred embodiment of the present invention;

FIG. 8 shows a side view of the orifice insert of FIG. 5 demonstrating a first configuration of a flow-control groove in accordance with a preferred embodiment of the present invention;

FIG. 9 shows a side view of the orifice insert of FIG. 5 demonstrating a second configuration of a flow-control groove in accordance with an alternative preferred embodiment of the present invention; and

FIG. 10 shows a side view of the orifice insert of FIG. 5 demonstrating a third configuration of a flow-control groove in accordance with another alternative preferred embodiment of the present invention.

### DETAILED DESCRIPTION OF THE PREFERRED EMBODIMENTS

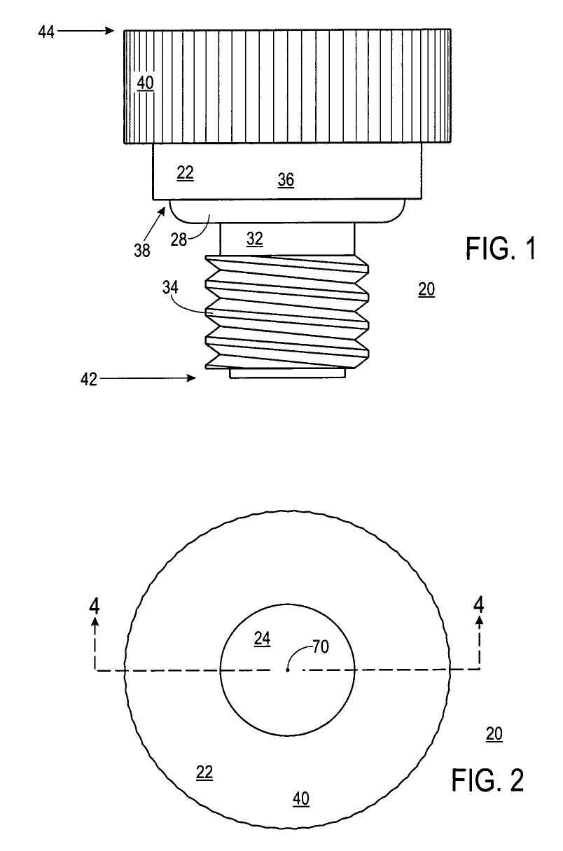

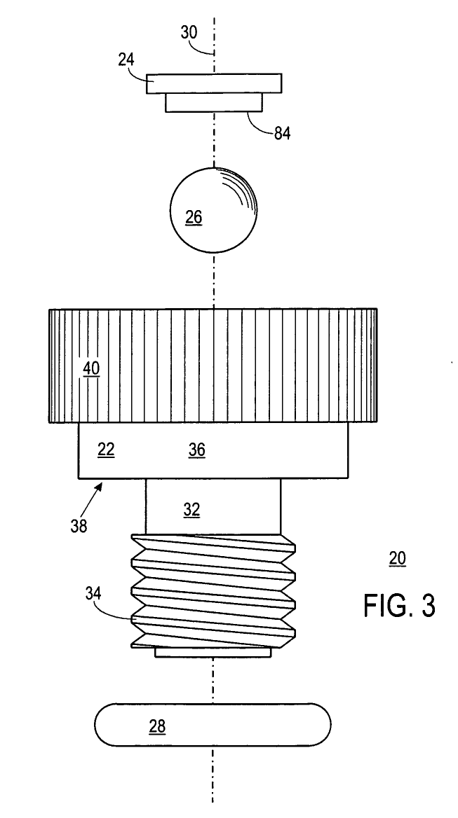

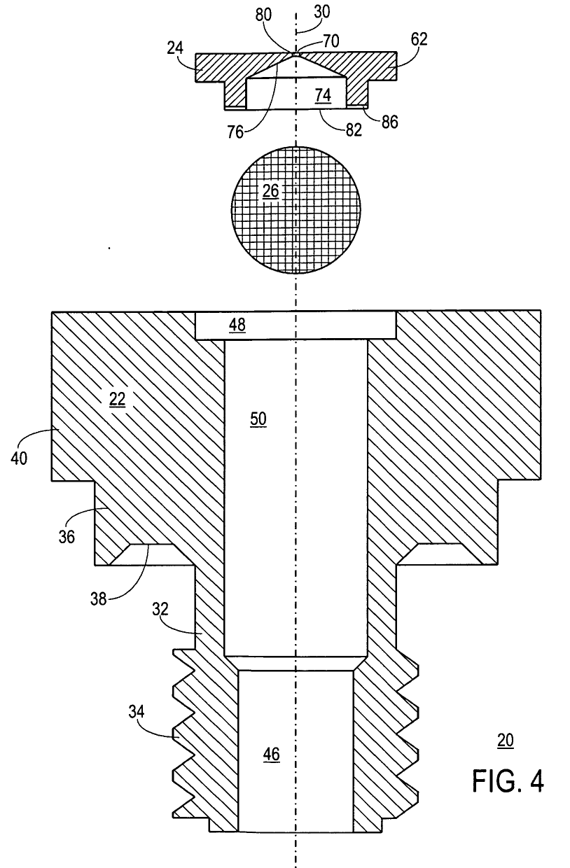

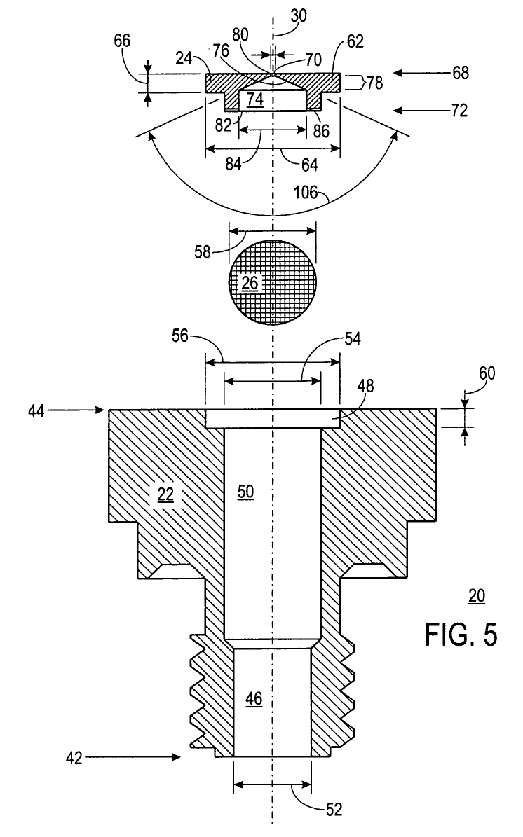

In accordance with a preferred embodiment of the present invention, FIGS. 1 and 2 show front and top views of an atomizing nozzle 20, FIG. 3 shows an exploded front view of atomizing nozzle 20 demonstrating components thereof, and FIGS. 4 and 5 show exploded cross-sectional front views of atomizing nozzle 20 taken at line 4-4 of FIG. 2 and demonstrating the internal structure and dimensional properties thereof. The following discussion refers to FIGS. 1 through 5.

Atomizing nozzle 20 forms a misting nozzle or head for use in a misting system (not shown) well known to those of ordinary skill in the art. Atomizing nozzle 20 is made up of a nozzle body 22, an orifice insert 24, an occluder 26, and an o-ring 28.

In the preferred embodiment, nozzle body 22 is formed of a series of substantially cylindrical shapes having a common axis 30, which serves as axis 30 for the entirety of atomizing nozzle 20.

Nozzle body 22 has a substantially cylindrical shank 32. Upon shank 32 are formed threads 34, with which atomizing nozzle 20 may be secured to piping or fittings in the misting system (not shown). Above shank 32, nozzle body 22 desirably has a substantially cylindrical seat 36, which is larger than shank 32. Seat 36 prohibits atomizing nozzle 20 from being screwed into the pipe or fitting of the misting system too far. Within seat 36 is an o-ring seat 38. O-ring 28 sits in o-ring seat 38, and allows a tight seal to be formed between atomizing nozzle 20 and the pipe or fitting of the misting system into which it is screwed without undue pressure. Above seat 36, nozzle body 22 desirably expands into a knob 40. Knob 40 is desirably knurled to increase friction, allowing atomizing nozzle 20 to be screwed into or out of the pipe or fitting of the misting system using hand-pressure alone.

Those skilled in the art will appreciate that these external features of atomizing nozzle 20 are not requirements of the present invention. Alternative embodiments of these features may be incorporated without departing from the spirit of the present invention.

Nozzle body 22, i.e., atomizing nozzle 20, has an inlet end 42 and an outlet end 44. An inlet channel 46 is formed into nozzle body 22 from inlet end 42. In the preferred embodiment, inlet channel 46 is desirably substantially cylindrical and substantially coaxial with nozzle axis 30. It will be appreciated, however, that this is not a requirement of the present invention. Alternative embodiments of inlet channel 46 may be used without departing from the spirit of the present invention.

Similarly, an insert recess 48 is formed into nozzle body 22 from outlet end 44. In the preferred embodiment, insert recess 48 is desirably substantially cylindrical and substantially coaxial with nozzle axis 30. It will be appreciated, however, that this is not a requirement of the present invention. Alternative embodiments of insert recess 48 may be used without departing from the spirit of the present invention.

An occluder chamber 50 is formed within nozzle body 22. Desirably, occluder chamber 50 is substantially coaxial with nozzle axis 30 and contiguous with inlet channel 46 and insert recess 48. In the preferred embodiment, occluder chamber 50 is desirably substantially cylindrical. It will be appreciated, however, that this is not a requirement of the present invention. Alternative embodiments of occluder chamber 50 may be used without departing from the spirit of the present invention.

Inlet channel 46, occluder chamber 50, and insert recess 48 together form a passage through nozzle body 22 along nozzle axis 30. Inlet channel 46 and insert recess 48 extend through nozzle body 22 from occluder chamber 50 to inlet end 42 and body outlet end 44, respectively.

Inlet channel 46 has an inlet channel diameter 52. Occluder chamber 50 has an occluder chamber diameter 54 greater than inlet channel diameter 52. Insert recess 48 has a recess diameter 56 greater than occluder chamber diameter 54.

Occluder 26 is substantially spherical and configured to reside within occluder chamber 50. Occluder 26 has an occluder diameter 58 which is greater than inlet channel diameter 52 and less than occluder chamber diameter 54. The operation and functionality of occluder 26 is discussed in greater detail hereinafter.

Orifice insert 24 is configured to be affixed to nozzle body 22 proximate outlet end 44. An insert flange 62 is formed upon orifice insert 24 and configured to mate with insert recess 48 formed within nozzle body 22.

In the preferred embodiment, insert recess 48 and insert flange 62 are substantially cylindrical and substantially coaxial with nozzle axis 30. Those skilled in the art will appreciate, however, that this is not a requirement of the present invention and that other mating forms of insert recess 48 and insert flange 62 may be used without departing from the spirit of the present invention.

In the preferred embodiment, insert recess 48 is formed with recess diameter 56 and a recess depth 60. Insert flange 62 is formed with a flange diameter 64 and a flange depth 66. Recess diameter 56 is substantially equal to flange diameter 64 and recess depth 60 is equal to or greater than flange depth 66. Insert flange 62 is configured to fit within insert recess 48, thereby affixing orifice insert 24 to nozzle body 22. Desirably, orifice insert 24 is press fit into nozzle body 22 using conventional techniques well known to those of ordinary skill in the art. It will be appreciated, however, that this is not a requirement of the present invention, and other methods of affixing orifice insert 24 to nozzle body 22 may be utilized without departing from the spirit of the present invention.

Orifice insert 24 has an orifice end 68, in which is found an orifice 70, and a chamber end 72 opposite orifice end 68. A substantially cylindrical insert chamber 74 is formed into orifice insert 24 from chamber end 72. Desirably, insert chamber 74 is substantially coaxial with nozzle axis 30. Ignoring occluder 26, insert chamber 74 is contiguous with occluder chamber 50 when orifice insert 24 is affixed to nozzle body 22.

A substantially conical chamber bevel 76 is formed into orifice insert 24. Desirably, chamber bevel 76 is substantially coaxial with nozzle axis 30, and forms an outlet end 78 of insert chamber 74.

A substantially cylindrical orifice channel 80 is formed through orifice insert 24 from insert chamber 74 to orifice end 68 of orifice insert 24. Orifice channel 80 is substantially coaxial with nozzle axis 30 and contiguous with insert chamber 74. An outer end of orifice channel 80 forms orifice 70.

A mating surface 82 is formed at chamber end 72 of orifice insert 24. Mating surface 82 is configured to mate with occluder 26. Insert chamber 74 has an insert chamber diameter 84. Insert chamber diameter 84 is less than occluder diameter 58, preventing occluder 26 from fully entering insert chamber 74.

In the preferred embodiment of the Figures, mating surface 82 is substantially perpendicular to nozzle axis 30. In this embodiment, a surface of occluder 26 mates with an inner edge of mating surface 82, where mating surface 82 encounters insert chamber 74. Those skilled in the art will appreciate, however, that this is not a requirement of the present invention. Other embodiments of mating surface 82 may be realized without departing from the spirit of the present invention.

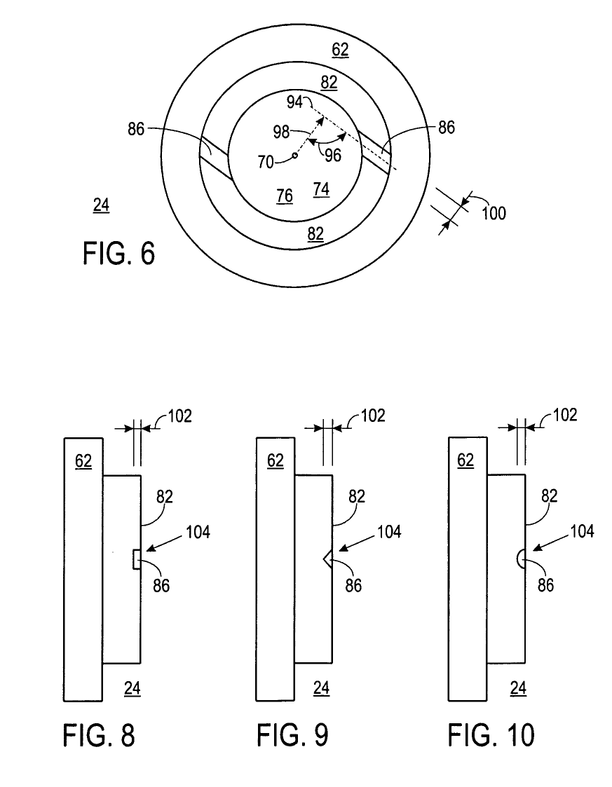

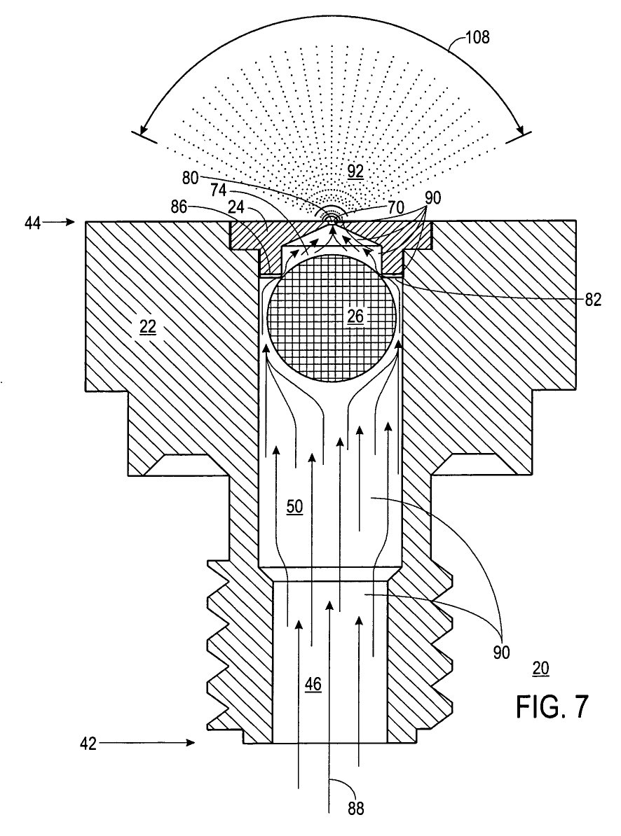

In accordance with preferred embodiments of the present invention, FIG. 6 shows a bottom view of orifice insert 24 for atomizing nozzle 20 demonstrating flow-control grooves 86, and FIG. 7 shows a cross-sectional front view of atomizing nozzle 20 taken at line 4-4 of FIG. 2 and demonstrating the operation thereof. The following discussion refers to FIGS. 4, 5, 6, and 7.

At least one flow-control groove 86 is formed into mating surface 82 of orifice insert 24. In the preferred embodiments, a plurality of substantially identical flow-control grooves is formed into mating surface 82. It will be appreciated that the number of flow-control grooves 86 formed into mating surface 82 is not germane to the present invention.

During operation, a fluid 88, typically water, passes through a fluid passage 90 through atomizing nozzle 20 to emerge as a mist 92. Fluid passage 90 consists of inlet channel 46, occluder chamber 50, flow-control grooves 86, insert chamber 74, and orifice channel 80.

Fluid 88 enters inlet end 42 of atomizing nozzle 20 under pressure. Fluid 88 flows through inlet channel 46 and into occluder chamber 50.

Because fluid 88 is under pressure, fluid 88 drives occluder 26 towards outlet end 44. Occluder 26 meets and mates with mating surface 82 of orifice insert 24. The pressure of fluid 88 holds occluder 26 against mating surface 82 as long as atomizing nozzle 20 is in use.

Unlike the substantially cylindrical impeller, also known as a poppet or plunger, of the prior art, occluder 26 does not vibrate, spin, or move during the operation of atomizing nozzle 20. The pressure of fluid 88 holds occluder firmly against mating surface 82, preventing occluder from moving. Occluder 26 effectively occludes the free passage of fluid 88 between occluder chamber 50 and insert chamber 74.

Because occluder 26 is substantially spherical, occluder 26 cannot misalign with orifice insert 24 and insert chamber 74 therein. It will be appreciated that were occluder 26 to perfectly mate with mating surface 82, occluder 26 would effectively inhibit atomizing nozzle 20 from operating. It is therefore neither necessary nor desirable that the sphericity of occluder 26 be perfect. Occluder 26 need only be substantially spherical.

FIGS. 8, 9, and 10 show side views of orifice insert 24 demonstrating variant configurations of flow-control grooves 86 in accordance with preferred embodiments of the present invention. The following discussion refers to FIGS. 4, 5, 6, 7, 8, 9, and 10.

Since occluder 26 effectively occludes the free passage of fluid 88 between occluder chamber 50 and insert chamber 74, it is desirable that some means other than leakage be provided to allow fluid 88 to pass into insert chamber 74. In order to pass into insert chamber 74, fluid 88 passes through flow control grooves 86. Flow control grooves 86 therefore extend from occluder chamber 50 to insert chamber 74, allowing the passage of fluid 88. Fluid 88 is forced around occluder 26 and through flow-control grooves 86 into insert chamber 74.

Desirably, each flow-control groove 86 is formed into mating surface 82 so a groove axis 94 of that flow-control groove 86 forms a groove angle 96 of approximately 90°±45° relative to an axis radius 98 emanating from nozzle axis 30. When flow-control grooves 86 are thus angularly formed into mating surface 82, fluid 88 passing through flow-control grooves 86 will spin inside insert chamber 74. This spinning begins the process of fractionating fluid 88 to form mist 92. Those skilled in the art will appreciate that this is not a requirement of the present invention. Other methods of forming flow-control grooves 86 and/or causing fluid 88 to spin within insert chamber 74 may be used without departing from the spirit of the present invention.

Chamber bevel 76 at outlet end 78 of insert chamber 74 causes the spin of fluid 88 to increase as fluid 88 approaches orifice channel 80. Fluid 88 passes through orifice channel 80 and emerges from orifice 70 as mist 92.

Control of fluid 88 through atomizing nozzle 20 is achievable in several different ways, which may be utilized severally or in conjunction.

Flow-control grooves 86 have a groove width 100 and a groove depth 102, demonstrated in FIGS. 6, 8, 9, and 10. Flow-control grooves 86 also have a cross-sectional configuration or groove shape 104. Groove shape 104 is demonstrated as rectangular (FIG. 8), V-shaped (FIG. 9), and arcuate (FIG. 10). It will be appreciated that groove shape 104 is not limited to the shapes demonstrated in FIGS. 8, 9, and 10, and that other cross-sectional configurations may be utilized without departing from the spirit of the present invention.

The flow of fluid 88 through flow-control grooves 86 is a function of groove width 100, groove depth 102, and groove shape 104. Varying any of these properties directly affects the flow of fluid 88 through atomizing nozzle 20.

The spin of fluid 88 within insert chamber 74 is a function of groove axis 94, i.e., of groove angle 96 of groove axis 94 relative to axis radius 98 of nozzle axis 30. Varying groove angle 96 and/or a length of axis radius 98 controls the spin of fluid 88 within insert chamber 74, hence the degree of fractionation of fluid 88 and the fineness of mist 92.

Occluder 26 mates with mating surface 82, which forms the chamber end 72 of insert chamber 74. Occluder 26 has occluder diameter 58. Insert chamber 74 has an insert chamber diameter 84 which is less than occluder diameter 58. Occluder 26 therefore can fit only partway into insert chamber 74. The relationship between occluder diameter 58 and insert chamber diameter 84 determines how far occluder 26 fits into insert chamber 74 when occluder 26 is mated with mating surface 82. The flow of fluid 88 from occluder chamber 50 to insert chamber 74 is a function of how far occluder 26 fits into insert chamber 74. Varying insert chamber diameter 84 relative to occluder diameter 58 controls the flow of fluid 88 between occluder chamber 50 and insert chamber 74, i.e., through atomizing nozzle 20.

Chamber bevel 76 forming outlet end 78 of insert chamber 74 has a bevel angle 106. Mist 92 emanates from atomizing nozzle 20 as a cloud having a mist output angle 108. Mist output angle 108 is a function of bevel angle 106. Varying bevel angle 106 will vary mist output angle 108.

In summary, the present invention teaches an atomizing nozzle 20 with a spherical occluder 26. Spherical occluder 26 is used in lieu of the conventional cylindrical impeller of the prior art, thereby significantly reducing the possibility of impeller misalignment. Flow-control grooves 86 are used in conjunction with spherical occluder 26 to control the flow of fluid 88 through atomizing nozzle 20. An insert chamber 74 having a chamber bevel 76 at its outlet end 78 serve to control a mist output angle 108.

Although the preferred embodiments of the invention have been illustrated and described in detail, it will be readily apparent to those skilled in the art that various modifications may be made therein without departing from the spirit of the invention or from the scope of the appended claims.

What is claimed is:

1: An atomizing nozzle for use in a misting system, said atomizing nozzle comprising:
a nozzle body having an inlet end, having an outlet end, and comprising an occluder chamber;
an orifice insert configured to be affixed to said nozzle body proximate said outlet end and comprising a substantially cylindrical insert chamber configured to be contiguous with said occluder chamber; and
a substantially spherical occluder configured to reside within said occluder chamber.

2: An atomizing nozzle as claimed in claim 1 wherein said insert chamber is substantially coaxial with said occluder chamber.

3: An atomizing nozzle as claimed in claim 1 wherein said occluder chamber is substantially cylindrical.

4: An atomizing nozzle as claimed in claim 1 wherein:
said orifice insert has an orifice end and a chamber end;
said insert chamber is formed into said orifice insert from said chamber end;
said orifice insert additionally comprises a substantially conical bevel formed into said orifice insert and configured to be substantially coaxial with said insert chamber and to form an outlet end of said insert chamber;
said orifice insert additionally comprises an orifice channel formed through said orifice insert from said insert chamber to said orifice end and configured to be substantially coaxial with said insert chamber;
said orifice insert additionally comprises a mating surface formed at said chamber end of said orifice insert; and
said orifice insert additionally comprises a flow-control groove formed into said mating surface and configured to extend from said occluder chamber to said insert chamber.

5: An atomizing nozzle as claimed in claim 4 wherein said flow-control groove has a groove axis forming a grove angle of 90°±45° with a radius of an axis of said occluder chamber.

6: An atomizing nozzle for use in a misting system, said atomizing nozzle comprising:
a nozzle body comprising an occluder chamber formed to be substantially coaxial with a nozzle axis;
an orifice insert comprising:
a substantially cylindrical insert chamber configured to be substantially coaxial with said nozzle axis;
a mating surface formed at a chamber end of said orifice insert; and
a flow-control groove formed into said mating surface of said orifice insert and configured to extend from said occluder chamber to said insert chamber; and
an occluder configured to reside within said occluder chamber and mate with said mating surface.

7: An atomizing nozzle as claimed in claim 6 wherein said flow-control groove has a groove axis forming a grove angle of 90°±45° win a radius of said nozzle axis.

8: An atomizing nozzle as claimed in claim 6 wherein said flow-control groove is formed to extend from said occluder chamber to said insert chamber.

9: An atomizing nozzle as claimed in claim 6 wherein said occluder is substantially spherical.

10: An atomizing nozzle as claimed in claim 6 wherein said occluder chamber is substantially cylindrical.

11: An atomizing nozzle as claimed in claim 6 wherein:
said insert chamber has an insert chamber diameter;
said occluder has an occluder diameter greater than said insert chamber diameter; and
said occluder chamber has an occluder chamber diameter greater than said occluder diameter.

12: An atomizing nozzle as claimed in claim 6 wherein:
said insert chamber is formed into said orifice insert from said chamber end thereof;
said orifice insert additionally comprises a substantially conical bevel formed into said orifice insert, configured to be substantially coaxial with said nozzle axis, and configured to form an outlet end of said insert chamber; and
said orifice insert additionally comprises an orifice channel formed through said orifice insert from said insert chamber to an orifice end of said orifice insert and configured to be substantially coaxial with said nozzle axis.

13: An atomizing nozzle as claimed in claim 6 wherein:
said insert flange is substantially cylindrical and substantially coaxial with said nozzle axis;
said insert recess is substantially cylindrical and substantially coaxial with said nozzle axis;
said insert flange has a flange diameter;
said insert flange has a flange depth;
said insert recess has a recess diameter;
said insert recess has a recess depth;
said recess diameter is substantially equal to said flange diameter; and
said recess depth is greater than or equal to said flange depth.

14: An atomizing nozzle configured to convert a fluid into a mist, said atomizing nozzle comprising:
a nozzle body;
an orifice insert affixed to an outlet end of said nozzle body;
a fluid passage passing through said atomizing nozzle and substantially coaxial with an axis of said atomizing nozzle, said fluid passage comprising:
an inlet channel formed within said nozzle body from an inlet end thereof, wherein said fluid enters said atomizing nozzle through said inlet channel;
an occluder chamber formed within said nozzle body and contiguous with said inlet channel;
a flow-control groove formed in a mating surface at a chamber end of said orifice insert and contiguous with said occluder chamber;
an insert chamber formed within said orifice insert and contiguous with said flow-control groove;
an orifice channel formed within said orifice insert, contiguous with said insert chamber, wherein said fluid exits said atomizing nozzle from said orifice channel as said mist; and
an occluder configured to reside within said occluder chamber and mate with said mating surface to substantially occlude passage of said fluid from said occluder chamber to said insert chamber except through said flow-control groove.

15: An atomizing nozzle as claimed in claim 14 wherein said occluder is substantially spherical.

16: An atomizing nozzle as claimed in claim 14 wherein said flow-control groove is substantially tangentially formed in said mating surface.

17: An atomizing nozzle as claimed in claim 14 wherein said flow-control groove is one of a plurality of substantially identical flow-control grooves.

18: An atomizing nozzle as claimed in claim 14 wherein:
said flow-control groove comprises;
a groove cross-sectional configuration;
a groove depth; and
a groove width; and
a flow of said fluid through said atomizing nozzle is a function of said groove cross-sectional configuration, said groove depth, and said groove width.

19: An atomizing nozzle as claimed in claim 14 wherein:
said insert chamber has an insert chamber diameter;
said occluder has an occluder diameter greater than said insert chamber diameter; and
a flow of said fluid through said atomizing nozzle is a function of said insert chamber diameter and said occluder diameter.

20: An atomizing nozzle as claimed in claim 14 wherein:
said insert chamber comprises a substantially conical bevel forming an outlet end of said insert chamber;
said bevel has a bevel angle; and
an output angle of said mist is a function of said bevel angle.
